(19) United States
(12) Patent Application Publication
(10) Pub. No.: US 2020/0209848 A1
(43) Pub. Date: Jul. 2, 2020

(54) SERVICE DEGRADATION IN AN AUTONOMOUS DRIVING SYSTEM

(71) Applicant: Mentor Graphics Development (Deutschland) GmbH, Wilsonville, OR (US)

(72) Inventors: Ljubo Mercep, München (DE); Matthias Pollach, München (DE); Johannes Mauthe, München (DE)

(21) Appl. No.: 16/237,348

(22) Filed: Dec. 31, 2018

(51) Int. Cl. G05D 1/00; G07C 5/08

(52) U.S. Cl. CPC G05D 1/0055; G05D 2201/0213; G07C 5/0808; G05D 1/0088

(57) ABSTRACT

This application discloses degradation of an assisted or automated driving system for a vehicle based on detected faults. A computing system implementing autonomous driving functionality can detect a fault in an autonomous driving system of the vehicle based on measurement data collected by the vehicle, determine an impact of the fault on object perception in an environment around the vehicle, and prompt a control system in the vehicle to degrade operation of the vehicle based, at least in part, on the impact of the fault on object perception in the environment around the vehicle. The computing system may prompt the control system in the vehicle to reduce a speed of the vehicle, alter a driving strategy for the vehicle, or to have the vehicle enter a safe state.

### TECHNICAL FIELD

This application is generally related to automated driving and assistance systems and, more specifically, to service degradation of vehicle operation by automated driving or assistance systems.

### BACKGROUND

Many modern vehicles include built-in advanced driver assistance systems (ADAS) to provide automated safety and/or assisted driving functionality. For example, these advanced driver assistance systems can have applications to implement adaptive cruise control, automatic parking, automated braking, blind spot monitoring, collision avoidance, driver drowsiness detection, lane departure warning, or the like. The next generation of vehicles can include autonomous driving (AD) systems to control and navigate the vehicles independent of human interaction.

These vehicles typically include multiple sensors, such as one or more cameras, a Light Detection and Ranging (LIDAR) sensor, a Radio Detection and Ranging (RADAR) system, ultrasonic, or the like, to measure the environment around the vehicles. Applications in advanced driver assistance systems or autonomous driving systems can detect objects within their field of view, and then utilize the detected objects to implement automated safety and/or driving functionality.

When the advanced driver assistance systems or autonomous driving systems experience sensor faults, the advanced driver assistance systems or autonomous driving systems may incorrectly detect objects or fail to detect objects. When the advanced driver assistance systems or autonomous driving systems experience actuator or other system faults, the advanced driver assistance systems or autonomous driving systems may be unable to implement automated safety and/or driving functionality as expected.

### SUMMARY

This application discloses degradation of an assisted or automated driving system for a vehicle based on detected faults. A computing system implementing autonomous driving functionality can detect a fault in an autonomous driving system of the vehicle based on measurement data collected by the vehicle, determine an impact of the fault on object perception in an environment around the vehicle, and prompt a control system in the vehicle to degrade operation of the vehicle based, at least in part, on the impact of the fault on object perception in the environment around the vehicle. The computing system may prompt the control system in the vehicle to reduce a speed of the vehicle, alter a driving strategy for the vehicle, or to have the vehicle enter a safe state. Embodiments will be described below in greater detail.

### DESCRIPTION OF THE DRAWINGS

FIG. 1 illustrates an example autonomous driving system according to various embodiments.

FIG. 2A illustrates an example measurement coordinate fields for a sensor system deployed in a vehicle according to various embodiments.

FIG. 2B illustrates an example environmental coordinate field associated with an environmental model for a vehicle according to various embodiments.

FIG. 3 illustrates an example sensor fusion system according to various examples.

FIG. 4 illustrates an example vehicle monitoring system according to various examples.

FIG. 5 illustrates an example flowchart for implementing service degradation in vehicle operation according to various examples.

FIGS. 6 and 7 illustrate an example of a computer system of the type that may be used to implement various embodiments of the invention.

### DETAILED DESCRIPTION

### Autonomous Driving System

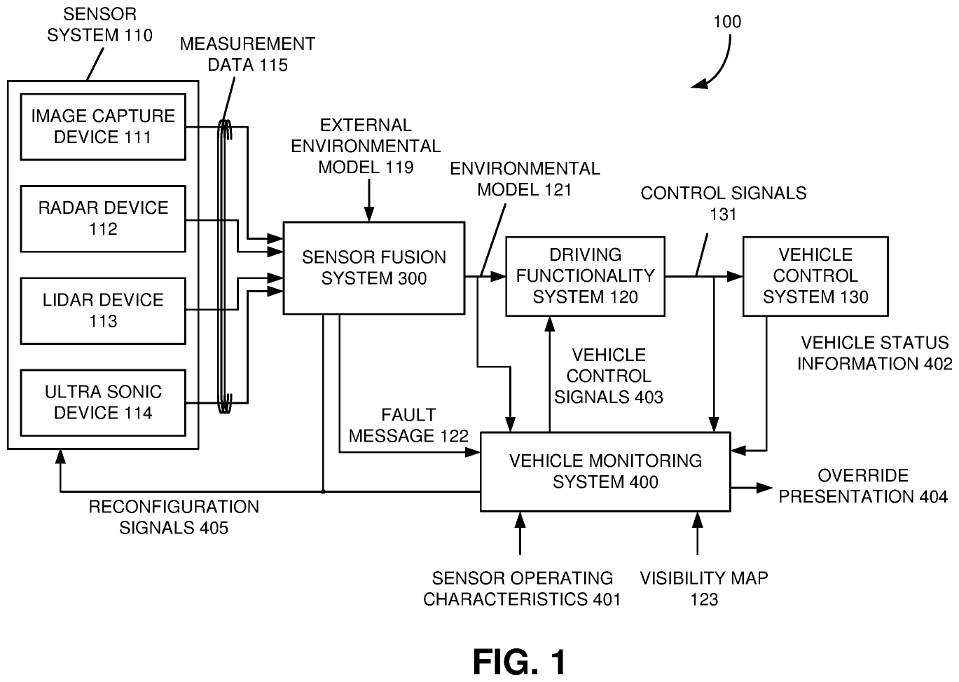

FIG. 1 illustrates an example autonomous driving system 100 according to various embodiments. Referring to FIG. 1, the autonomous driving system 100, when installed in a vehicle, can sense an environment around or adjacent to the vehicle and control operation of the vehicle based, at least in part, on the sensed environment. In some embodiments, the vehicle can be an automobile, a car, a truck, an airplane, a drone, a train, a robot, an autonomous guided vehicle (AGV), for example, located in a factory environment, a mining vehicle, a tractor, or the like.

The autonomous driving system 100 can include a sensor system 110 having multiple sensors to measure the environment around or adjacent to the vehicle. The sensor system 110 can output the measured environment as measurement data 115. The measurement data 115 can include raw measurements from sensors in the sensor system 110, such as characteristics of light, electromagnetic waves, or sound captured by the sensors, such as an intensity or a frequency of the light, electromagnetic waves, or the sound, an angle of reception by the sensors, a time delay between a transmission and the corresponding reception of the light, electromagnetic waves, or the sound, a time of capture of the light, electromagnetic waves, or sound, or the like.

The sensor system 110 can include multiple different types of sensors, such as an image capture device 111, a Radio Detection and Ranging (RADAR) device 112, a Light Detection and Ranging (LIDAR) device 113, an ultra-sonic device 114, one or more microphones, infrared or night-vision cameras, time-of-flight cameras, cameras capable of detecting and transmitting differences in pixel intensity, or the like.

The image capture device 111, such as one or more cameras or event-based cameras, can capture at least one image of at least a portion of the environment around or adjacent to the vehicle. The image capture device 111 can output the captured image(s) as measurement data 115, which, in some embodiments, can be unprocessed and/or uncompressed pixel data corresponding to the captured image(s).

The RADAR device 112 can emit radio signals into the environment around or adjacent to the vehicle. Since the emitted radio signals may reflect off of objects in the environment, the RADAR device 112 can detect the reflected radio signals incoming from the environment. The RADAR device 112 can measure the incoming radio signals by, for example, measuring a signal strength of the radio signals, a reception angle, a frequency, or the like. The RADAR device 112 also can measure a time delay between an emission of a radio signal and a measurement of the incoming radio signals from the environment that corresponds to emitted radio signals reflected off of objects in the environment. The RADAR device 112 can output the measurements of the incoming radio signals as the measurement data 115.

The LIDAR device 113 can transmit light, such as from a laser or other optical transmission device, into the environment around or adjacent to the vehicle. The transmitted light, in some embodiments, can be pulses of ultraviolet light, visible light, near infrared light, or the like. Since the transmitted light can reflect off of objects in the environment, the LIDAR device 113 can include a photo detector to measure light incoming from the environment. The LIDAR device 113 can measure the incoming light by, for example, measuring an intensity of the light, a wavelength, or the like. The LIDAR device 113 also can measure a time delay between a transmission of a light pulse and a measurement of the light incoming from the environment that corresponds to the transmitted light having reflected off of objects in the environment. The LIDAR device 113 can output the measurements of the incoming light and the time delay as the measurement data 115.

The ultra-sonic device 114 can emit acoustic pulses, for example, generated by transducers or the like, into the environment around or adjacent to the vehicle. The ultra-sonic device 114 can detect ultra-sonic sound incoming from the environment, such as, for example, the emitted acoustic pulses having been reflected off of objects in the environment. The ultra-sonic device 114 also can measure a time delay between emission of the acoustic pulses and reception of the ultra-sonic sound from the environment that corresponds to the emitted acoustic pulses having reflected off of objects in the environment. The ultra-sonic device 114 can output the measurements of the incoming ultra-sonic sound and the time delay as the measurement data 115.

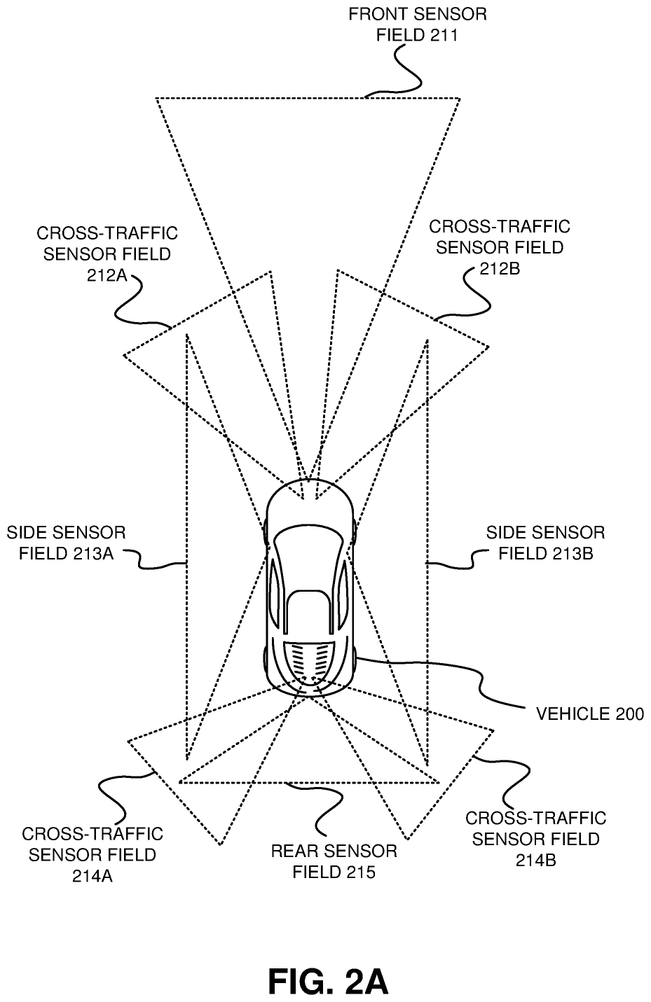

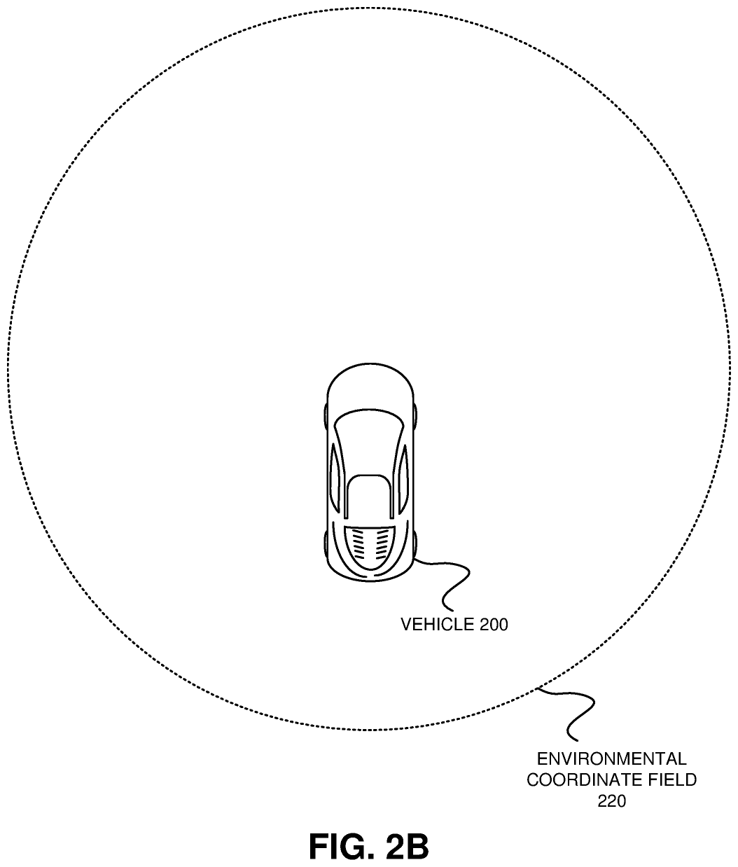

The different sensors in the sensor system 110 can be mounted in the vehicle to capture measurements for different portions of the environment around or adjacent to the vehicle. FIG. 2A illustrates an example measurement coordinate fields for a sensor system deployed in a vehicle 200 according to various embodiments. Referring to FIG. 2A, the vehicle 200 can include multiple different sensors capable of detecting incoming signals, such as light signals, electromagnetic signals, and sound signals. Each of these different sensors can have a different field of view into an environment around the vehicle 200. These fields of view can allow the sensors to measure light and/or sound in different measurement coordinate fields.

The vehicle in this example includes several different measurement coordinate fields, including a front sensor field 211, multiple cross-traffic sensor fields 212A, 212B, 214A, and 214B, a pair of side sensor fields 213A and 213B, and a rear sensor field 215. Each of the measurement coordinate fields can be sensor-centric, meaning that the measurement coordinate fields can describe a coordinate region relative to a location of its corresponding sensor.

Referring back to FIG. 1, the autonomous driving system 100 can include a sensor fusion system 300 to receive the measurement data 115 from the primary sensor system 110 and to populate an environmental model 121 associated with the vehicle with the measurement data 115. In some embodiments, the environmental model 121 can have an environmental coordinate field corresponding to a physical envelope surrounding the vehicle, and the sensor fusion system 300 can populate the environmental model 121 with the measurement data 115 based on the environmental coordinate field. In some embodiments, the environmental coordinate field can be a non-vehicle centric coordinate field, for example, a world coordinate system, a path-centric coordinate field, a coordinate field parallel to a road surface utilized by the vehicle, or the like.

FIG. 2B illustrates an example environmental coordinate field 220 associated with an environmental model for the vehicle 200 according to various embodiments. Referring to FIG. 2B, an environment surrounding the vehicle 200 can correspond to the environmental coordinate field 220 for the environmental model. The environmental coordinate field 220 can be vehicle-centric and provide a 360 degree area around or encapsulating the vehicle 200. The environmental model can be populated and annotated with information detected by the sensor fusion system 300 or inputted from external sources. Embodiments will be described below in greater detail.

Referring back to FIG. 1, the sensor fusion system 300 can spatially align the measurement data 115 to the environmental coordinate field of the environmental model 121. The sensor fusion system 300 also can identify when the sensors captured the measurement data 115, for example, by time stamping the measurement data 115 when received from the sensor system 110. The sensor fusion system 300 can populate the environmental model 121 with the time stamp or other time-of-capture information, which can be utilized to temporally align the measurement data 115 in the environmental model 121. In some embodiments, the sensor fusion system 300 can analyze the measurement data 115 from the multiple sensors as populated in the environmental model 121 to detect a sensor event or at least one object in the environmental coordinate field associated with the vehicle. The sensor event can include a sensor measurement event corresponding to a presence of the measurement data 115 in the environmental model 121, for example, above a noise threshold. The sensor event can include a sensor detection event corresponding to a spatial and/or temporal grouping of the measurement data 115 in the environmental model 121. The object can correspond to spatial grouping of the measurement data 115 having been tracked in the environmental model 121 over a period of time, allowing the sensor fusion system 300 to determine the measurement data 115 corresponds to an object around the vehicle. The sensor fusion system 300 can populate the environment model 121 with an indication of the detected sensor event or detected object and a confidence level of the detection.

The sensor fusion system 300 also can generate a visibility map 123 to identify which portions of the environmental coordinate field of the environmental model 121 can be populated with measurement data 115 and identify which of the sensors in the sensor system 110 can populate the environmental coordinate field of the environmental model 121. In some embodiments, the sensor fusion system 300 can determine which portions, if any, of sensor measurement coordinate fields may be blocked, for example, by an object, debris, or the like, and modify the visibility map 123 to identify the portions of the environmental coordinate field of the environmental model 121 that correspond to the blocked portions of the sensor measurement coordinate fields. For example, when another vehicle is located in front of the vehicle, one or more of the front facing sensors may not be able to capture measurements beyond the location of the other vehicle. In this instance, the sensor fusion system 300 can utilize the detection of vehicle to modify the visibility map 123.

The sensor fusion system 300, in some embodiments, can compare the environmental model 121 against another environmental model, such as an internally generated safety environmental model and/or a received external environmental model 119, to determine whether the sensor system 110 includes any faults or whether one or more internal processes of the sensor fusion system 300 include a fault. For example, one or more of the sensors in the sensor system 110 can become misaligned, malfunction, or have their field of view at least partially blocked by debris, or the like, which the sensor fusion system 300 may be able to detect based on a comparison of the safety environmental model and/or an external environmental model 119 against the environmental model 121. When the sensor fusion system 300 identifies one or more faults, the sensor fusion system 300 can generate a fault message 122, perform internal data modifications, or the like. The sensor fusion system 300 also may modify the visibility map 123 based on the faults or the fault message 122. Embodiments of the sensor fusion system will be described below in greater detail.

The autonomous driving system 100 can include a driving functionality system 120 to receive at least a portion of the environmental model 121 from the sensor fusion system 300. The driving functionality system 120 can analyze the data included in the environmental model 121 to implement automated driving functionality or automated safety and assisted driving functionality for the vehicle. The driving functionality system 120 can generate control signals 131 based on the analysis of the environmental model 121.

The autonomous driving system 100 can include a vehicle control system 130 to receive the control signals 131 from the driving functionality system 120. The vehicle control system 130 can include mechanisms to control operation of the vehicle, for example by controlling different functions of the vehicle, such as braking, acceleration, steering, parking brake, transmission, user interfaces, warning systems, or the like, in response to the control signals 131.

The autonomous driving system 100 can include a vehicle monitoring system 400 to detect or predict faults in the vehicle and prompt service degradation by the vehicle based, at least in part, on the detected or predicted faults in the vehicle. The vehicle monitoring system 400 can receive information from the sensor fusion system 300, such as the environmental model 121, the external environmental model 119, the fault message 122, the visibility map 123, or the like. The vehicle monitoring system 400 also can receive sensor operating characteristics 401, for example, from the sensor system 110. The sensor operating characteristics 401 can include operating temperature, electrical characteristics, such as operating voltage or current consumption, refresh rate, or the like. The vehicle monitoring system 400 can receive the control signals 131 from the driving functionality system 120. The vehicle monitoring system 400 can receive vehicle status information 402 from the vehicle control system 130, which can include operation or performance of actuators in the vehicle, for example, controlling acceleration, braking, steering, drive-by-wire functionality, or the like.

The vehicle monitoring system 400 can detect or predict faults in the vehicle based on one or more of the environmental model 121, the external environmental model 119, the fault message 122, the visibility map 123, the control signals 131, the sensor operating characteristics 401, and vehicle status information 402. The vehicle monitoring system 400, based on the detected or predicted faults in the vehicle, can generate vehicle control signals 403, an override presentation 404, or reconfiguration signals 405. The vehicle control signals 403 can be configured to prompt the driving functionality system 120 to generate control signal 131 that modify a service provided by autonomous driving system 100. For example, the driving functionality system 120, based on the control signals 131, can generate control signals 131 that prompt the vehicle control system 130 to reduce speed, travel to a safe state, avoid traveling on highways, or the like.

The vehicle monitoring system 400 can implement a human-machine interface device in the vehicle, which can annunciate or present the detected or predicted faults within the vehicle. For example, the vehicle monitoring system 400 can prompt display of the override presentation 405 on a display device located in the vehicle, which can annunciate or present the detected or predicted faults within the vehicle. The display device also may detect user interaction with the override presentation 405 and provide information to the vehicle monitoring system 400 based on the detected user interaction. For example, the override presentation 405 can include a manual override option that, when selected by the user via the display device, can allow the display device to provide an indication of a manual override of the detected or predicted fault to the vehicle monitoring system 400. The vehicle monitoring system 400 also can annunciate or present the detected or predicted faults within the vehicle via an auditory human-machine interface device or a button-based human-machine interface device, for example, located on a steering wheel or dashboard of the vehicle.

The reconfiguration signals 403 can be configured to prompt the sensor system 110 to recalibrate one or more of its sensors. For example, the sensor system 110, in response to the reconfiguration signals 403, can re-position at least one of its sensors, expand a field of view of at least one of its sensors, change a refresh rate or exposure time of at least one of its sensors, alter a mode of operation of at least one of its sensors, or the like. Embodiments of a vehicle monitoring system will be described below in greater detail.

### Sensor Fusion System in an Autonomous Driving System

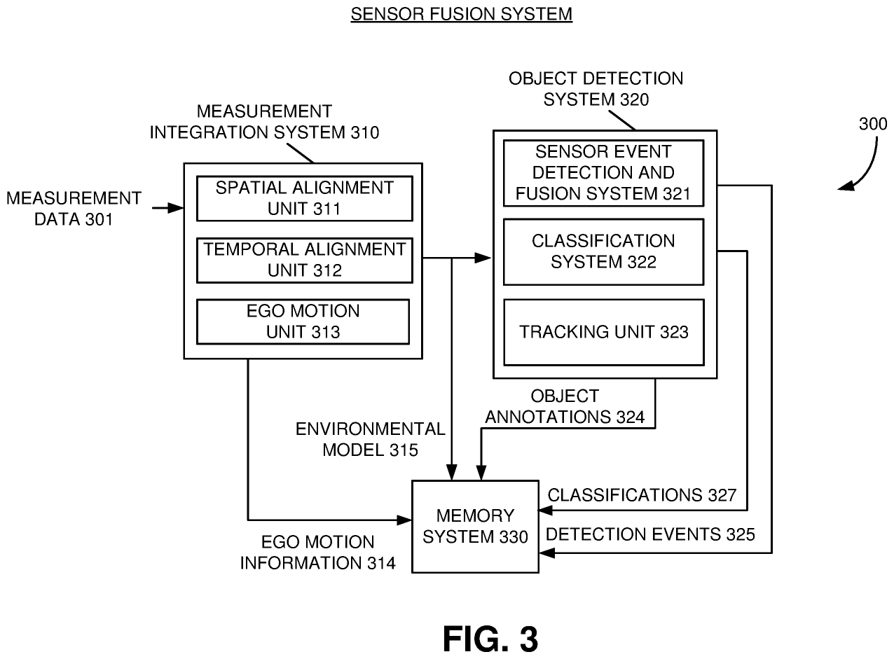

FIG. 3 illustrates an example sensor fusion system 300 in an autonomous driving system 100 according to various examples. Referring to FIG. 3, the sensor fusion system 300 can include a measurement integration system 310 to generate an environmental model 315 for the vehicle, which can be populated with the measurement data 301. The measurement integration system 310 can include a spatial alignment unit 311 to correlate measurement coordinate fields of the sensors to an environmental coordinate field for the environmental model 315. The measurement integration system 310 can utilize this correlation to convert or translate locations for the measurement data 301 within the measurement coordinate fields into locations within the environmental coordinate field. The measurement integration system 310 can populate the environmental model 315 with the measurement data 301 based on the correlation between the measurement coordinate fields of the sensors to the environmental coordinate field for the environmental model 315.

The measurement integration system 310 also can temporally align the measurement data 301 from different sensors in the sensor system. In some embodiments, the measurement integration system 310 can include a temporal alignment unit 312 to assign time stamps to the measurement data 301 based on when the sensor captured the measurement data 301, when the measurement data 301 was received by the measurement integration system 310, or the like. In some embodiments, the temporal alignment unit 312 can convert a capture time of the measurement data 301 provided by the sensors into a time corresponding to the sensor fusion system 300. The measurement integration system 310 can annotate the measurement data 301 populated in the environmental model 315 with the time stamps for the measurement data 301. The time stamps for the measurement data 301 can be utilized by the sensor fusion system 300 to group the measurement data 301 in the environmental model 315 into different time periods or time slices. In some embodiments, a size or duration of the time periods or time slices can be based, at least in part, on a refresh rate of one or more sensors in the sensor system. For example, the sensor fusion system 300 can set a time slice to correspond to the sensor with a fastest rate of providing new measurement data 301 to the sensor fusion system 300.

The measurement integration system 310 can include an ego motion unit 313 to compensate for movement of at least one sensor capturing the measurement data 301, for example, due to the vehicle driving or moving in the environment. The ego motion unit 313 can generate ego motion information 314, such as an estimated motion of the sensors, a change in the estimated motion of the sensors over time, or the like. The ego motion unit 313 can estimate the motion of the sensor capturing the measurement data 301, for example, by utilizing tracking functionality to analyze vehicle motion information, such as global positioning system (GPS) data, inertial measurements, vehicle odometer data, video images, or the like. The tracking functionality can implement a Kalman filter, a Particle filter, optical flow-based estimator, or the like, to track motion of the vehicle and its corresponding sensors relative to the environment around or adjacent to the vehicle.

The ego motion unit 313 can utilize the estimated motion of the sensor to modify the correlation between the measurement coordinate field of the sensor to the environmental coordinate field for the environmental model 315 and, optionally, to modify the visibility map stored in a memory system 330. This modification of the correlation can allow the measurement integration system 310 to populate the environmental model 315 with the measurement data 301 at locations of the environmental coordinate field where the measurement data 301 was captured as opposed to the current location of the sensor at the end of its measurement capture.

In some embodiments, the ego motion information 314 can be utilized to self-diagnose a fault with one or more of the sensors. For example, when the ego motion information 314 corresponds to motion that the vehicle is incapable of undergoing or movement that exceeds physical or ordinary capabilities of the vehicle, the ego motion unit 313, the sensor fusion system 300 or other device in the autonomous driving system 100 can determine a fault corresponding to the sensor measurements utilized to estimate the motion of the sensors. The ego motion unit 313 can estimate the motion of the sensors, for example, by utilizing tracking functionality to analyze vehicle motion information, such as global positioning system (GPS) data, inertial measurements, vehicle odometer data, video images, or the like, by using a correlation of sensor data with map data, such as High Definition (HD) map data used for vehicle localization, by using radial velocity present in RADAR data, by extracting the skew of LiDAR point clouds caused by ego vehicle movement, or the like. The tracking functionality can implement a Kalman filter, a Particle filter, optical flow-based estimator, or the like, to track motion of the vehicle and its corresponding sensors relative to the environment around or adjacent to the vehicle. When the ego motion unit 313 identifies a fault based on data from the ego motion information 314, the ego motion unit 313 can embed an indication of the fault within the ego motion information 314, which can be stored in the memory system 330 or signaled to the other components of the system, which can orchestrate a vehicle safety strategy.

In some embodiments, the measurement data 301 can include objects or object lists. The measurement integration system 310 can receive the object list from sources external to the vehicle, such as in a vehicle-to-vehicle (V2V) communication, a vehicle-to-infrastructure (V2I) communication, a vehicle-to-pedestrian (V2P) communication, a vehicle-to-device (V2D) communication, a vehicle-to-grid (V2G) communication, or generally a vehicle-to-everything (V2X) communication. The measurement integration system 410 also can receive the objects or an object list from other systems internal to the vehicle, such as from a human machine interface, mapping systems, localization system, driving functionality system, vehicle control system, or the vehicle may be equipped with at least one sensor that outputs the object list.

The object list may include one or more objects, a time stamp for each object, and optionally include a spatial metadata associated with a location of objects in the object list. For example, the object list can include speed measurements for the vehicle, which may not include a spatial component to be stored in the object list as the spatial metadata. When the object list includes a confidence level associated with an object in the object list, the measurement integration system 310 also can annotate the environmental model 315 with the confidence level for the object from the object list.

The measurement integration system 310 can store the environmental model 315 in the memory system 330. The measurement integration system 310 also can store the ego motion information 314, such as the estimated motion of the sensors, a change in the estimated motion of the sensors, or the like, determined by the ego motion unit 313 into the memory system 330.

The sensor fusion system 300 can include an object detection system 320 to receive the environmental model 315, for example, from the measurement integration system 310 or by accessing the environmental model 315 stored in the memory system 330. The object detection system 320 can analyze data stored in the environmental model 315 to detect at least one object. The sensor fusion system 300 can populate the environment model 315 with an indication of the detected object at a location in the environmental coordinate field corresponding to the detection. The object detection system 320 can identify confidence levels corresponding to the detected object, which can be based on at least one of a quantity, a quality, or a sensor diversity of measurement data 301 utilized in detecting the object. The sensor fusion system 300 can populate or store the confidence levels corresponding to the detected objects with the environmental model 315. For example, the object detection system 320 can annotate the environmental model 315 with object annotations 324 or the object detection system 320 can output the object annotations 324 to the memory system 330, which populates the environmental model 315 with the detected object and corresponding confidence level of the detection in the object annotations 324.

The object detection system 320 can include a sensor event detection and fusion system 321 to identify detection events 325 from the data stored in the environmental model 315. In some embodiments, the sensor event detection and fusion system 321 can identify the detection events 325 by analyzing the data stored in the environmental model 315 on a per-sensor-type basis to identify patterns in the data, such as image features or data point clusters. When the sensor event detection and fusion system 321 utilizes patterns from a single sensor modality or type to generate the detection events 325, the detection event 325 may be called a sensor detection event. In some embodiments, the sensor event detection and fusion system 321 also can associate or correlate identified patterns across multiple different sensor modalities or types to generate the detection event 325, which can be called a fused sensor detection event.

The sensor event detection and fusion system 321 also can determine differences from adjacent frames or scans of the sensor measurement data on a per-sensor-type basis. For example, the sensor event detection and fusion system 321 can compare the received sensor measurement data from a type of sensor against sensor measurement data from a previously received frame or scan from that type of sensor to determine the differences from adjacent frames or scans of the sensor measurement data. The sensor event detection and fusion system 321 can perform this inter-frame and intra-modality comparison of the sensor measurement data based, at least in part, on the spatial locations of the sensor measurement data in the environmental model 315. For example, when an image capture sensor provides entire image frames, the sensor event detection and fusion system 321 can cache the entire image frames, determine inter-frame differences for the sensor measurement data from a plurality of the cached image frames. In another example, when an image capture sensor provided event-based pixels, the sensor event detection and fusion system 321 can perform pixel caching to generate an entire image from the image data. The sensor event detection and fusion system 321 can utilize the event-based pixels as the inter-frame differences in the sensor measurement data. In another example, when one or more of the RADAR sensors provides raw signal data in a frequency domain, the sensor event detection and fusion system 321 can detect one or more untracked targets from RADAR measurements. The sensor event detection and fusion system 321 can determine differences between the untracked targets in adjacent frames, which can constitute inter-frame differences in the sensor measurement data for the RADAR sensor modality.

The sensor event detection and fusion system 321 also can identify faults associated with sensor fusion during the object detection. The sensor event detection and fusion system 321 can utilize the visibility map, for example, stored in the memory system 330, to identify which sensors were capable of contributing measurement data 301 during the object detection. In some embodiments, the sensors can be capable of contributing measurement data 301 during the object detection when their corresponding measurement coordinate fields overlap with a location corresponding to the object detection.

The sensor event detection and fusion system 321 can determine whether the measurement data 301 from each of the sensors capable of contributing measurement data 301 was utilized or fused during object detection to identify sensor detection events or fused sensor detection events. For example, when the visibility map indicates that three different sensors had measurement coordinate fields overlapping with sensor detection events or fused sensor detection events, but measurement data 301 from two sensors were utilized by the sensor event detection and fusion system 321 during the sensor fusion, the sensor event detection and fusion system 321 can identify a fault associated with the sensor that did not contribute measurement data during the sensor fusion. The sensor event detection and fusion system 321 can store the identified fault to the memory system 330, utilize the fault to recalibrate one or more of the sensors, or the like.

The sensor fusion system 300 can populate or store the detection events 325 with the environmental model 315. For example, the object detection system 320 can annotate the environmental model 315 with the detection events 325, or the object detection system 320 can output the detection events 325 to the memory system 330, which populates the environmental model 315 with the detection events 325.

The object detection system 320 can include a classification system 322 to classify sensor measurement data associated with the detection events 325. In some embodiments, the classification system 322 can assign classifications 327 to the detection events 325 based on the sensor measurement data associated with the detection events 325. The classifications 327 can correspond to a type of object associated with the detection events 325, such as another vehicle, a pedestrian, a cyclist, an animal, a static object, or the like. The classifications 327 also can include a confidence level associated with the classification and/or include more specific information corresponding to a particular pose, orientation, state, or the like, of the object type. In some embodiments, the classification system 322 can implement multiple different types of classification, each of which can generate classifications 327 associated with the detection events 325. The object detection system 320 can annotate the environmental model 315 with the classifications 327 or the object detection system 320 can output the classifications 327 to the memory system 330, which populates the environmental model 315 with the classifications 327.

The classification system 322 can implement multiple different classifiers, which can independently classify the sensor measurement data associated with the detection events 325. For example, the classification system 322 can implement at least one classifier having one or more object models, each to describe a type of object capable of being located proximate to the vehicle. The object models can include matchable data for different object types, and include poses, orientations, transitional states, potential deformations for the poses or orientations, textural features, or the like, to be compared against the sensor measurement data. The classification system 322 can compare the sensor measurement data (or a modified representation of the sensor measurement data) associated with the detection events 325 to one or more of the object models, and generate the classifications 327 based on the comparison.

The multiple classifications 327 of the sensor measurement data associated with the detection event 325 can be utilized to self-diagnose any faults in the classifiers utilized to generate the classifications 327. For example, when the classifiers in the classification system 322 generate different classifications 327 for the same detection event 325, the sensor fusion system 300 can generate a fault message to indicate a presence of divergent classifications of sensor measurement data associated with the detection event 325. In some embodiments, when the classifiers in the classification system 322 detect an unexpected change in a classification of an detected object the sensor fusion system 300 can identify a fault in the classification system 322 or the sensor system. For example, when the classification system 322 has classified an object as a pedestrian with a high confidence level, and then switches the classification to a bicycle after a short period of time, the sensor fusion system 300 can generate the fault message to indicate a presence of a fault in the classifications of sensor measurement data associated with the detection event 325 or the sensor measurement data itself.

Since classification mismatches can occur due to a reason other than a fault, for example, due to a known weakness of an individual classifier, adverse weather conditions, bad optical visibility, or the like, the sensor fusion system 300 may detect an uncertainty in its ability to classify an object and lower a confidence level of any classification. In some embodiments, when the sensor fusion system 300 identifies divergent classifications, the sensor fusion system 300 can assume both of the multiple classifications 327 are accurate and keep multiple corresponding classification hypotheses active in the vehicle. In other embodiments, when the sensor fusion system 300 identifies divergent classifications, the sensor fusion system 300 can assume that the classification corresponding to a more vulnerable road user type, for example, a bicycle being more vulnerable than a vehicle, is accurate.

The object detection system 320 can include a tracking unit 323 to track the detection events 325 in the environmental model 315 over time, for example, by analyzing the annotations in the environmental model 315, and determine whether the detection events 325 corresponds to objects in the environmental coordinate system. In some embodiments, the tracking unit 323 can utilize the classifications 327 to track the detection events 325 with at least one state change prediction model, such as a kinetic model, a probabilistic model, or other state change prediction model.

The tracking unit 323 can select the state change prediction model to utilize to track the detection events 325 based on the assigned classifications 327 of the detection events 325. The state change prediction model may allow the tracking unit 323 to implement a state transition prediction, which can assume or predict future states of the detection events 325, for example, based on a location of the detection events 325 in the environmental model 315, a prior movement of the detection events 325, a classification of the detection events 325, or the like. In some embodiments, the tracking unit 323 implementing the kinetic model can utilize kinetic equations for velocity, acceleration, momentum, or the like, to assume or predict the future states of the detection events 325 based, at least in part, on its prior states.

The tracking unit 323 may determine a difference between the predicted future states of the detection events 325 and its actual future states, which the tracking unit 323 may utilize to determine whether the detection events 325 correspond to objects proximate to the vehicle. The tracking unit 323 can track the detection event 325 in the environmental coordinate field associated with the environmental model 315, for example, across multiple different sensors and their corresponding measurement coordinate fields.

When the tracking unit 323, based on the tracking of the detection events 325 with the state change prediction model, determines the detection events 325 are trackable, the tracking unit 323 can annotate the environmental model 315 to indicate the presence of trackable detection events. The tracking unit 323 can continue tracking the trackable detection events over time by implementing the state change prediction models and analyzing the environmental model 315 when updated with additional measurement data 301. After annotating the environmental model 315 to indicate the presence of trackable detection events, the tracking unit 323 can continue to track the trackable detect events in the environmental coordinate field associated with the environmental model 315, for example, across multiple different sensors and their corresponding measurement coordinate fields.

In some embodiments, the tracking unit 323 can be utilized in a self-diagnosis of faults with one or more of the sensors. For example, when the tracking unit 323 identifies motion of measurement data 301 in the environmental model 315 that corresponds to motion the tracked object is incapable of undergoing, for example, that exceeds physical or ordinary capabilities of the object being tracked, the identification of that motion can be utilized to determine a fault corresponding to the measurement data 301 or to determine high uncertainty in the initial assumption of that object classification. Since the tracking unit 323 can compensate for the ego motion of the vehicle based on the ego motion information 314 during the tracking of the object, the tracking unit 323 can analyze the ego motion information 314 to determine whether a detected fault lies with the ego motion information 314 for the vehicle or the tracking functionality in the tracking unit 323. In some embodiments, the tracking unit 323 can determine the fault based on the identification of that motion or the tracking unit 323 can store the identified motion in the memory system 330 as one or more of the object annotations 324.

The sensor fusion system 300 can utilize data, such as the measurement data 301, the environmental model 315, ego motion information 314, object annotations 324, classifications 327, detection events 325, to determine whether at least one fault exists in the sensor system capturing the measurement data 301 or within the sensor fusion system 300 itself. The sensor fusion system 300 can analyze the information to detect faults, such as sensor faults, data processing faults by the sensor fusion system 300, or the like, and generate one or more fault messages in response to the detected faults. In some embodiments, the fault messages can identify a fault type, information associated with the detection event, and/or a context associated with the identification of the fault, such as the measurements collected by the sensors, the conditions associated with the vehicle, e.g., vehicle speed, external terrain, external lighting, vehicle location, weather conditions, or the like. In some embodiments, the fault messages may prompt measurement data from faulty sensors to be marked invalid, so the sensor fusion system 300 does not utilize that measurement data in object detection around or adjacent to the vehicle. The fault messages also may be utilized to prompt the autonomous driving system to enter a safety mode of operation, which can alter driving strategy and functionality for the autonomous driving system. In some embodiments, the autonomous driving system can prompt a passenger of the vehicle or a source external to the vehicle, such as a remote service operator or infrastructure computation center, to disambiguate the uncertain or faulty situation.

### Service Degradation in an Autonomous Driving System

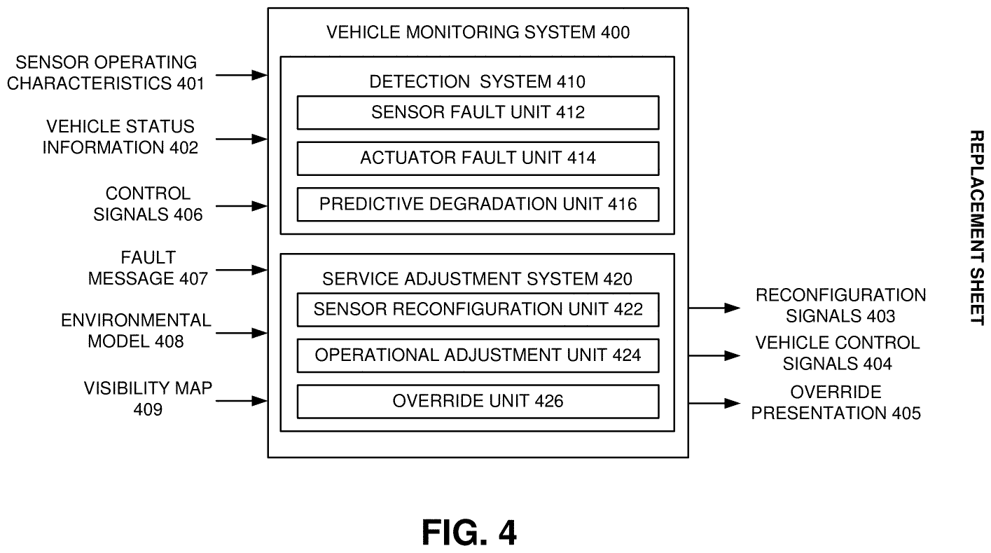

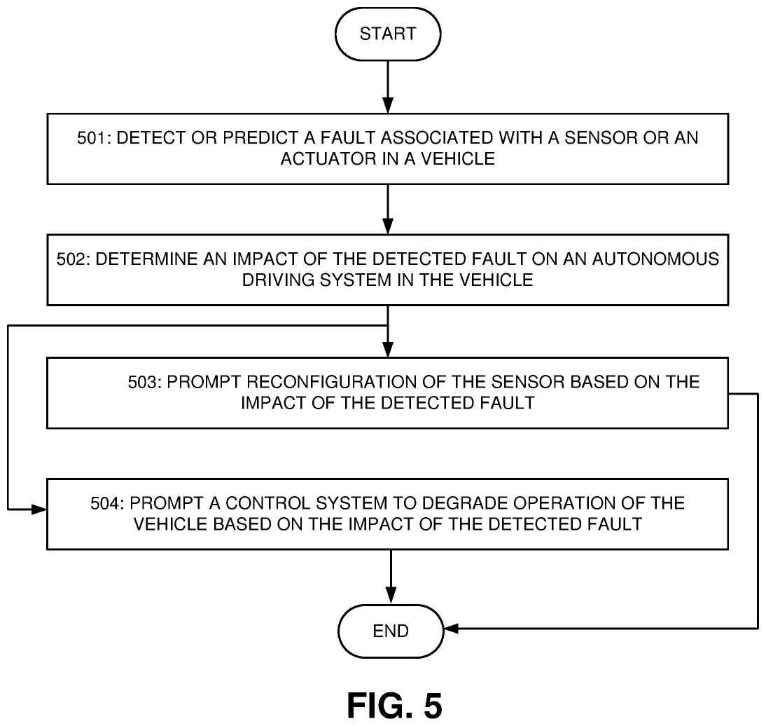

FIG. 4 illustrates an example vehicle monitoring system 400 to implement service degradation in vehicle operation according to various examples. FIG. 5 illustrates an example flowchart for implementing service degradation in vehicle operation according to various examples. Referring to FIGS. 4 and 5, in a block 501, the vehicle monitoring system 400 can detect or predict faults in a vehicle and prompts service degradation of the vehicle based, at least in part, on the detected or predicted faults in the vehicle. The vehicle monitoring system 400 can receive sensor operating characteristics 401, vehicle status information 402, control signals 406, a fault message 407, an environmental model 408, and a visibility map 409. The sensor operating characteristics 401 can include operating temperature, electrical characteristics, such as operating voltage or current consumption, refresh rate, or the like, of sensors in the vehicle. The vehicle status information 402 can include operation or performance of actuators in the vehicle, for example, controlling acceleration, braking, steering, drive-by-wire functionality, a Global Positioning System (GPS) functionality, or the like.

The control signals 406 can prompt mechanisms in the vehicle to control operation of the vehicle, for example by controlling different functions of the vehicle, such as braking, acceleration, steering, parking brake, transmission, user interfaces, warning systems, or the like. The fault message 407 can identify a presence of a detected fault within the vehicle, and can include a fault type, context associated with the identification of the fault, such as measurements collected by sensors, conditions associated with the vehicle, e.g., vehicle speed, external terrain, external lighting, vehicle location, weather conditions, or the like. The environmental model 408 can have an environmental coordinate field populated with sensor measurement data and/or events corresponding to processed data corresponding to a physical space near the vehicle. In some embodiments, the environmental model 408 can be vehicle-centric, for example, having an environmental coordinate field associated with a physical envelope encapsulating or surrounding the vehicle. The environmental model 408 also can have a non-vehicle-centric environmental coordinate field, such as a global map-based coordinate system. The visibility map 409 can identify which portions of the environmental coordinate field of the environmental model 408 can be populated with measurement data and identify which of the sensors can populate the environmental coordinate field of the environmental model 408.

The vehicle monitoring system 400 can include a detection system 410 to detect faults in one or more portions of the vehicle, such as faults associated with one or more of the sensors or actuators in the vehicle. The detection system 410 also can predict when a fault in the vehicle may occur and, for example, generate a time-to-failure metric based on the fault prediction, monitoring of historical sensor performance, sensor fusion, the other vehicle systems, or the like.

The detection system 410 can include a sensor fault unit 412 to detect faults associated with one or more of the sensors mounted in the vehicle. In some embodiments, the sensor fault unit 412 can detect a fault within a sensor based on the fault message 407, which indicates a sensor fusion system in the vehicle detected a fault in the sensor. The sensor fault unit 412 can detect faults associated with one or more of the sensors mounted in the vehicle by comparing the environmental model 408 against models of expected sensor behavior or sensor models and identifying when sensor measurement data populated in the environmental model 408 differs or disagrees with the sensor model. For example, when the environmental model 408 includes sensor measurement data in locations that deviate from the sensor model, the sensor fault unit 412 can determine a fault exists with the sensor.

The sensor fault unit 412 can detect faults associated with one or more of the sensors mounted in the vehicle by comparing the environmental model 408 against the visibility map 409 and identifying when sensor measurement data populated in the environmental model 408 disagrees with the visibility map 409. For example, when the sensor measurement data is populated in the environmental model 408 in a location the visibility map 409 indicates should not include sensor measurement data, the sensor fault unit 412 can determine a fault exists with the sensor. In some embodiments, the sensor fault unit 412 can analyze the sensor operating characteristics 401 to identify a malfunction by at least one of the sensors in the vehicle. For example, when the sensor operating characteristics 401 indicate rotations-per-minute (RPM) of a motor in a LIDAR sensor fall below a preset threshold or become zero, the sensor fault unit 412 can determine the LIDAR sensor includes a fault.

The detection system 410 can include an actuator fault unit 414 to detect faults associated with one or more of the actuators, such as an accelerator, a braking system, a steering system, a drive-by-wire system, or the like, in the vehicle. In some embodiments, the actuator fault unit 414 can identify a fault within an actuator of the vehicle based on the vehicle status information 402, which can describe operation or performance of actuators in the vehicle. The actuator fault unit 414 also can detect a fault within an actuator of the vehicle by determining how the vehicle should respond to the control signals 406, and then comparing that determined response against the vehicle status information 402 or the environmental model 408. When the vehicle status information 402 or the environmental model 408 indicates the vehicle failed to respond as expected to the control signals 406, the actuator fault unit 414 can identify which of the actuators may include a fault. For example, when the control signals 406 prompt an actuator in the a brake system of the vehicle to slow movement of the vehicle, but the vehicle status information 402 or the data subsequently populated in the environmental model 408 indicates that vehicle did not reduce speed, the actuator fault unit 414 can identify an actuator in the brake system of the vehicle as including a fault.

The detection system 410 can include a predictive degradation unit 416 to predict future faults within the vehicle, such as the sensors, in-vehicle power supplies, actuators, or the like. The predictive degradation unit 416 can predict sensor faults based on a variety of factors, such as the sensor operating characteristics 401, the data populated in the environmental model 408, sensor aging heuristics, sensor cleaning systems, or the like. For example, the predictive degradation unit 416 can utilize the sensor operating characteristics 401 to identify factors indicative of a future sensor failure, such as increased power consumption by a sensor, aberrant or fluctuating LIDAR sensor motor operation, or the like. In some embodiments, the predictive degradation unit 416 also can utilize the environmental model 408 to determine whether one or more sensors has been capturing data more sparsely than expected, which be indicative of future sensor failure. In another example, the predictive degradation unit 416 can identify a volume of cleaning fluid associated with a sensor cleaning system, predict when the sensor cleaning system may run out of the cleaning fluid, and predict when a level of debris builds up onto the sensor sufficiently to constitute a sensor fault.

The predictive degradation unit 416 can predict actuator faults based a variety of factors, such as the vehicle status information 402, the control signals 406, the data populated in the environmental model 408, actuator aging heuristics, or the like. For example, the predictive degradation unit 416 can utilize the vehicle status information 402 and the data populated in the environmental model 408 to determine actuator performance in response to the control signals 406. When the predictive degradation unit 416 identifies a reduction in performance of an actuator, the predictive degradation unit 416 can generate a prediction of future actuator failure.

The predictive degradation unit 416 can determine when a power supply in the vehicle may fail based on vehicle status information 402, sensor operating characteristics 401, or the like. The predictive degradation unit 416 can identify voltage and/or current levels supplied to the various systems in the vehicle based on vehicle status information 402 and/or sensor operating characteristics 401, and then utilize the identified voltage and/or current levels to generate a prediction of future power supply failure. For example, when the identified voltage and/or current levels increase, reduce, or fluctuate over time, the predictive degradation unit 416 can generate a prediction of future power supply failure.

The predictive degradation unit 416 can utilize these predictive fault determinations to generate a time-to-failure metric, which can set a drive time, an actual time, a total driving distance, a driving trip range, or the like, until the vehicle includes a system failure. The predictive degradation unit 416 may generate the predictions of future failures in the vehicle, such as a time-to-failure metric, by accessing a look-up table with an input of vehicle conditions or status. The look-up table can be populated with data collected from a vehicle fleet, which may be analyzed, for example, utilizing machine learning algorithms. In some embodiments, the look-up table can be stored in a system memory of the vehicle and be populated with multiple different time-to-failure metrics indexed or referenced by various vehicle conditions. The look-up table also may be stored remotely to the vehicle, for example, in a computation backend system accessible over a remote connection. In some embodiments, the computation backend system can decide to take a vehicle out of service or reduce operating scenarios for the vehicle. For example, the predictive degradation unit 416 can utilize the volume of cleaning fluid to identify, in the look-up table, a time-to-failure metric corresponding to when a sensor will become obstructed by debris to the point of constituting a failure. In some embodiments, the predictive degradation unit 416 can utilize the look-up table to determine multiple different time-to-failure metrics based on different types of vehicle conditions or status, and select one of the time-to-failure metrics, for example, the smallest time-to-failure metric. When the look-up table stores time-to-failure metrics corresponding to different combinations of the vehicle conditions and/or statuses, the degradation unit 416 can utilize the look-up table to retrieve a time-to-failure metric corresponding to vehicle conditions or status.

In some embodiments, the predictive degradation unit 416 also can include a prediction engine to derive the time-to-failure metric based on the vehicle conditions or status. The prediction engine may derive the time-to-failure metric according to the specific configuration of the vehicle, such as a configuration of the sensors, types of sensors or actuators, type of power supplies, or the like. The predictive engine may implement a rules-based or learning-based model, which can utilize the vehicle conditions or status to generate the predictions of future failures in the vehicle, such as a time-to-failure metric. The predictive engine implementing the rules-based or learning-based model can utilize vehicle context data over time, such as power consumption, sparseness of sensor measurement data, motor operation for sensor, cleaning fluid volume, or the like, to determine a time-to-failure metric for the vehicle.

The vehicle monitoring system 400 can include a service adjustment system 420 to determine an impact of the faults detected or predicted by the detection unit 410, and prompt service adjustment by the vehicle based, at least in part, on the detected or predicted faults in the vehicle. In a block 502, when the service adjustment system 420 determines a sensor in the vehicle has or is predicted to become faulty, the service adjustment system 420 can determine an impact of the faulty sensor, such as which portions of the external environment of the vehicle may not be measured by a sensor in the vehicle. The service adjustment system 420 also can update the visibility map 409 based on the determined impact of the faulty sensor. When the service adjustment system 420 determines an actuator in the vehicle has or is predicted to become faulty, the service adjustment system 420 can determine an impact of the faulty actuator, such as which driving functionality of the vehicle may be affected due to the faulty actuator.

The service adjustment system 420 can include a sensor reconfiguration unit 422, which, in a block 503, can generate reconfiguration signals 403 based on the determined impact of a detected or predicted fault in the vehicle. In some embodiments, when the detected or predicted fault in the vehicle corresponds to a faulty sensor in a sensor system, the sensor reconfiguration unit 422 can generate reconfiguration signals 403 that prompt an alteration of how at least one sensor in the sensor system captures measurements. For example, the reconfiguration signals 403 also can prompt a camera in the sensor system to adjust spatial or temporal resolution, exposure levels, or the like. For a RADAR sensor, the reconfiguration signals 403 can prompt a switch between long-range and short-range detection, which can alter a field of view (FoV) or measurement coordinate fields, for example, to at least partially cover the measurement coordinate field associated with the faulty sensor. For a LIDAR sensor, the reconfiguration signals 403 can prompt alteration in a projected light pattern, a field of view or measurement coordinate field, output power, or the like. In some embodiments, the reconfiguration signals 403 can prompt the sensor system to reposition at least one of the sensors to have its measurement coordinate field at least partially cover the measurement coordinate field associated with the faulty sensor.

When the detected or predicted fault in the vehicle corresponds to a faulty actuator, the sensor reconfiguration unit 422 can generate reconfiguration signals 403 that prompt an alteration of measurement coordinate fields of one or more other sensors in the sensor system. For example, when an actuator in a braking system of the vehicle becomes faulty, the reconfiguration signals 403 can prompt the sensor system to extend a sensor measurement range in the front of the vehicle, for example, by repositioning at least one of the sensors to cover the extended sensor measurement range or by lengthening the sensor measurement field of at least one of the forward-facing sensors in the sensor system.

The service adjustment system 420 can include an operational adjustment unit 424, which in a block 504, can generate vehicle control signals 404 based on the determined impact of a detected or predicted fault in the vehicle. The operational adjustment unit 424 can output the vehicle control signals 404 to another system in the vehicle, such as a driving functionality system or a vehicle control system, which can prompt alteration of driving functionality for the vehicle. For example, the driving functionality system, based on the vehicle control signals 404, can set limits on vehicle speed, driving strategy, such as limiting vehicle access to certain roads, or the like. When the vehicle control signals 404 indicate it is no longer safe to drive the vehicle, the driving functionality system, based on the vehicle control signals 404, can identify a safe state for the vehicle, such as a location off of a road to pull over, stop the vehicle, and allow passengers to exit the vehicle.

In some embodiments, the operational adjustment unit 424 may implement a gradual, stepped, or consecutive approach to service degradation. For example, the operational adjustment unit 424 can generate a first set of vehicle control signals 404 to prompt a reduction of vehicle speed based on a fault detection or a fault prediction, and then, based on an additional fault detection or updated fault prediction, generate a second set of vehicle control signals 404 to prompt an alteration in driving strategy, such as avoiding highways, avoiding pedestrian areas, avoiding operating in low-light conditions, or the like. The operational adjustment unit 424 can continue to degrade service of the vehicle based on an additional fault detection or updated fault prediction, for example, having the vehicle proceed to an automotive repair shop or entering a safe state by stopping the vehicle and allowing passengers to safely exit the vehicle. The operational adjustment unit 424 can communicate a proposed operational adjustment to a passenger via human-machine interface device and can implement service degradation or operational adjustments based on received user input.

The service adjustment system 420 can include an override unit 426 to generate an override presentation 405 that, when displayed in the vehicle, can identify a detected fault, a determined impact of the detected fault on the sensing or driving capabilities of the vehicle, and/or a degradation of vehicle operation. In some embodiments, the override presentation 405 can be displayed on a human-machine interface, for example, which can interpret user input relative to the override presentation 405. For example, when the service adjustment system 420 intends to degrade service of the vehicle by restricting access to highways or other high-speed roadways, the service adjustment system 420 can generate the override presentation 405 indicating this intent for display in the vehicle. The override presentation 405 may include a section that, when selected via user input detected by a display device, can override this intent and allow the vehicle to operate without degraded service, such as utilizing highways or other high-speed roadways in its driving strategy.

In some embodiments, the override presentation 405, when displayed in the vehicle, can identify other services provided by an autonomous driving system. For example, the override presentation 405 can identify a driving route utilized by the autonomous driving system along with one or more alternate driving routes, which the display device can render selectable via user input. In another example, the override presentation 405 can identify a classification of an object external to the vehicle along with one or more alternate classifications, which the display device can render selectable via user input. The override unit 426 can present the override presentation 405 remotely from the vehicle, for example, at service backend system external to the vehicle, in another vehicle with different position, or the like, and receive remote input based on the override presentation 405.

### Illustrative Operating Environment

The execution of various driving automation processes according to embodiments of the invention may be implemented using computer-executable software instructions executed by one or more programmable computing devices. Because these embodiments of the invention may be implemented using software instructions, the components and operation of a programmable computer system on which various embodiments of the invention may be employed will be described below.

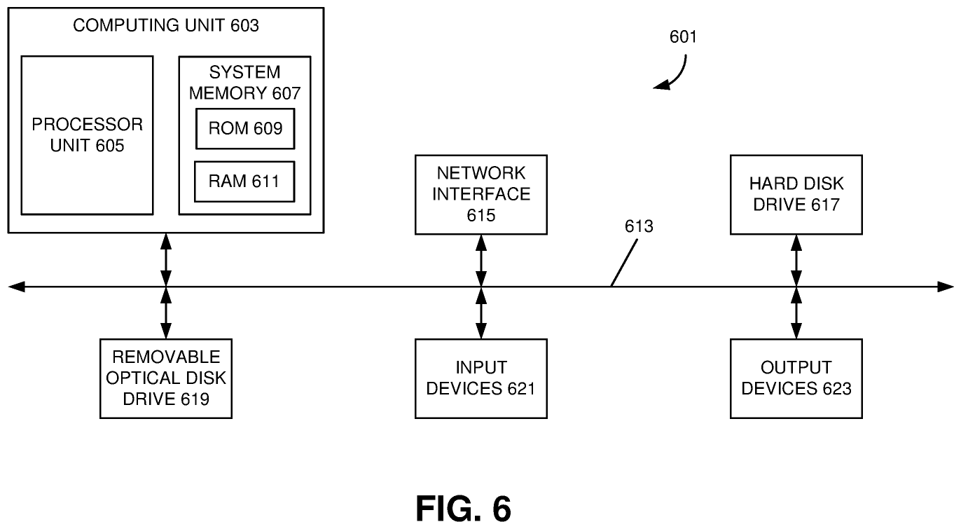

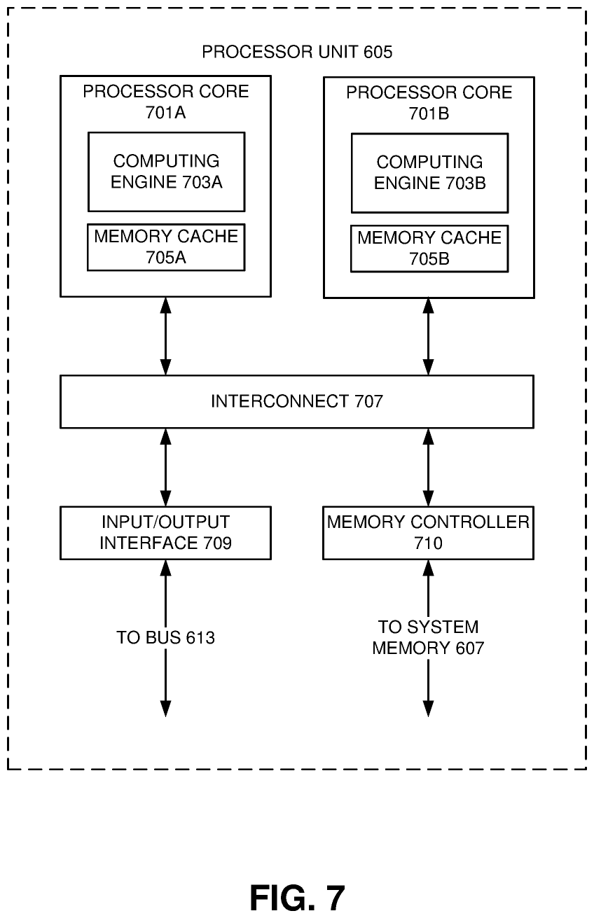

FIGS. 6 and 7 illustrate an example of a computer system of the type that may be used to implement various embodiments of the invention. Referring to FIG. 6, various examples of the invention may be implemented through the execution of software instructions by a computing device 601, such as a programmable computer. Accordingly, FIG. 6 shows an illustrative example of a computing device 601. As seen in FIG. 6, the computing device 601 includes a computing unit 603 with a processing unit 605 and a system memory 607. The processing unit 605 may be any type of programmable electronic device for executing software instructions, but will conventionally be a microprocessor. The system memory 607 may include both a read-only memory (ROM) 609 and a random access memory (RAM) 611. As will be appreciated by those of ordinary skill in the art, both the read-only memory (ROM) 609 and the random access memory (RAM) 611 may store software instructions for execution by the processing unit 605.

The processing unit 605 and the system memory 607 are connected, either directly or indirectly, through a bus 613 or alternate communication structure, to one or more peripheral devices 617-623. For example, the processing unit 605 or the system memory 607 may be directly or indirectly connected to one or more additional memory storage devices, such as a hard disk drive 617, which can be magnetic and/or removable, a removable optical disk drive 619, and/or a flash memory card. The processing unit 605 and the system memory 607 also may be directly or indirectly connected to one or more input devices 621 and one or more output devices 623. The input devices 621 may include, for example, a keyboard, a pointing device (such as a mouse, touchpad, stylus, trackball, or joystick), a scanner, a camera, and a microphone. The output devices 623 may include, for example, a monitor display, a printer and speakers. With various examples of the computing device 601, one or more of the peripheral devices 617-623 may be internally housed with the computing unit 603. Alternately, one or more of the peripheral devices 617-623 may be external to the housing for the computing unit 603 and connected to the bus 613 through, for example, a Universal Serial Bus (USB) connection.

With some implementations, the computing unit 603 may be directly or indirectly connected to a network interface 615 for communicating with other devices making up a network. The network interface 615 can translate data and control signals from the computing unit 603 into network messages according to one or more communication protocols, such as the transmission control protocol (TCP) and the Internet protocol (IP). Also, the network interface 615 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 601 is illustrated as an example only, and it not intended to be limiting. Various embodiments of the invention may be implemented using one or more computing devices that include the components of the computing device 601 illustrated in FIG. 6, which include only a subset of the components illustrated in FIG. 6, or which include an alternate combination of components, including components that are not shown in FIG. 6. For example, various embodiments of the invention may be implemented using a multi-processor computer, a plurality of single and/or multiprocessor computers arranged into a network, or some combination of both.

With some implementations of the invention, the processor unit 605 can have more than one processor core. Accordingly, FIG. 7 illustrates an example of a multi-core processor unit 605 that may be employed with various embodiments of the invention. As seen in this figure, the processor unit 605 includes a plurality of processor cores 701A and 701B. Each processor core 701A and 701B includes a computing engine 703A and 703B, respectively, and a memory cache 705A and 705B, respectively. As known to those of ordinary skill in the art, a computing engine 703A and 703B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 703A and 703B may then use its corresponding memory cache 705A and 705B, respectively, to quickly store and retrieve data and/or instructions for execution.

Each processor core 701A and 701B is connected to an interconnect 707. The particular construction of the interconnect 707 may vary depending upon the architecture of the processor unit 605. With some processor cores 701A and 701B, such as the Cell microprocessor created by Sony Corporation, Toshiba Corporation and IBM Corporation, the interconnect 707 may be implemented as an interconnect bus. With other processor units 701A and 701B, however, such as the Opteron™ and Athlon™ dual-core processors available from Advanced Micro Devices of Sunnyvale, Calif., the interconnect 707 may be implemented as a system request interface device. In any case, the processor cores 701A and 701B communicate through the interconnect 707 with an input/output interface 709 and a memory controller 710. The input/output interface 709 provides a communication interface between the processor unit 605 and the bus 613. Similarly, the memory controller 710 controls the exchange of information between the processor unit 605 and the system memory 607. With some implementations of the invention, the processor unit 605 may include additional components, such as a high-level cache memory accessible shared by the processor cores 701A and 701B. It also should be appreciated that the description of the computer network illustrated in FIG. 6 and FIG. 7 is provided as an example only, and it not intended to suggest any limitation as to the scope of use or functionality of alternate embodiments of the invention.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in a computer-readable memory device. The memory device may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory device may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory devices may be “read only” by design (ROM) by virtue of permission settings, or not. Other examples of memory devices may include, but may not be limited to, WORM, EPROM, EEPROM, FLASH, NVRAM, OTP, or the like, which may be implemented in solid state semiconductor devices. Other memory devices may comprise moving parts, such as a known rotating disk drive. All such memory devices may be “machine-readable” and may be readable by a processing device.

Operating instructions or commands may be implemented or embodied in tangible forms of stored computer software (also known as “computer program” or “code”). Programs, or code, may be stored in a digital memory device and may be read by the processing device. “Computer-readable storage medium” (or alternatively, “machine-readable storage medium”) may include all of the foregoing types of computer-readable memory devices, as well as new technologies of the future, as long as the memory devices may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above to refer to computing processes, it should be appreciated that various examples of the invention may be implemented using any desired combination of computing processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
detecting, by a computing system, a fault with one or more sensors mounted in a vehicle;
identifying, by the computing system, a portion of an environment around the vehicle unmeasured by the sensors due to the fault; and
prompting, by the computing system, reconfiguration of at least one of the sensors to capture measurements in the identified portion of the environment around the vehicle.

2. The method of claim 1, wherein the reconfiguration of at least one of the sensors further comprises repositioning at least one of the sensors mounted in the vehicle or altering how the at least one of the sensors captures measurements.

3. The method of claim 1 further comprising:
detecting, by the computing system, a fault with one or more actuators in the vehicle;
determining, by the computing system, an impact of the detected fault on an ability of the vehicle to perform driving operations; and
prompting, by the computing system, a control system to degrade operation of the vehicle based, at least in part, on the impact of the detected fault.

4. The method of claim 3, wherein the control system in the vehicle is configured to degrade operation of the vehicle by reducing a speed of the vehicle, altering a driving strategy, or stopping the vehicle in a safe state.

5. The method of claim 3 further comprising:
generating, by the computing system, a presentation to identify the impact of detected fault or the degraded operation for the control system to perform; and
overriding, by the computing system, the degraded operation in response to input corresponding the displayed presentation.

6. The method of claim 1 further comprises predicting when the fault will occur in the future based on an operation of the sensors or the actuators in the vehicle.

7. The method of claim 6 further comprising generating, by the computing system, a time-to-failure metric corresponding to a time available for the vehicle to continue in operation based on the predicted fault, wherein prompting the control system in the vehicle to degrade operation of the vehicle is based on the time-to-failure metric.

8. An apparatus comprising at least one memory device storing instructions configured to cause one or more processing devices to perform operations comprising:
detecting a fault with one or more sensors mounted in a vehicle;
identifying a portion of an environment around the vehicle unmeasured by the sensors due to the fault; and
prompting reconfiguration of at least one of the sensors to capture measurements in the identified portion of the environment around the vehicle.

9. The apparatus of claim 8, wherein the reconfiguration of at least one of the sensors further comprises repositioning at least one of the sensors mounted in the vehicle or altering how the at least one of the sensors captures measurements.

10. The apparatus of claim 8, wherein the instructions are further configured to cause the one or more processing devices to perform operations comprising:
detecting a fault with one or more actuators in the vehicle;
determining an impact of the detected fault on an ability of the vehicle to perform driving operations; and
prompting a control system to degrade operation of the vehicle based, at least in part, on the impact of the detected fault.

11. The apparatus of claim 10, wherein the control system in the vehicle is configured to degrade operation of the vehicle by reducing a speed of the vehicle, altering a driving strategy, or stopping the vehicle in a safe state.

12. The apparatus of claim 10, wherein the instructions are further configured to cause the one or more processing devices to perform operations comprising
generating a presentation to identify the impact of detected fault or the degraded operation for the control system to perform; and
overriding the degraded operation in response to input corresponding the displayed presentation.

13. The apparatus of claim 8, wherein the instructions are further configured to cause the one or more processing devices to perform operations comprising predicting when the fault will occur in the future based on an operation of the sensors or the actuators in the vehicle.

14. The apparatus of claim 13, wherein the instructions are further configured to cause the one or more processing devices to perform operations comprising generating a time-to-failure metric corresponding to a time available for the vehicle to continue in operation based on the predicted fault, wherein prompting the control system in the vehicle to degrade operation of the vehicle is based on the time-to-failure metric.

15. A system comprising:
a memory device configured to store machine-readable instructions; and
a computing system including one or more processing devices, in response to executing the machine-readable instructions, configured to:
detect a fault with one or more sensors mounted in a vehicle;
identify a portion of an environment around the vehicle unmeasured by the sensors due to the fault; and
prompt reconfiguration of at least one of the sensors to capture measurements in the identified portion of the environment around the vehicle.

16. The system of claim 15, wherein the reconfiguration of at least one of the sensors further comprises repositioning at least one of the sensors mounted in the vehicle or altering how the at least one of the sensors captures measurements.

17. The system of claim 16, wherein the one or more processing devices, in response to executing the machine-readable instructions, are configured to:
detect a fault with one or more actuators in the vehicle;
determine an impact of the detected fault on an ability of the vehicle to perform driving operations; and
prompt a control system to degrade operation of the vehicle based, at least in part, on the impact of the detected fault.

18. The system of claim 17, wherein the control system in the vehicle is configured to degrade operation of the vehicle by reducing a speed of the vehicle, altering a driving strategy, or stopping the vehicle in a safe state.

19. The system of claim 15, wherein the one or more processing devices, in response to executing the machine-readable instructions, are configured to predict when the fault will occur in the future based on an operation of the sensors or the actuators in the vehicle.

20. The system of claim 19, wherein the one or more processing devices, in response to executing the machine-readable instructions, are configured to generate a time-to-failure metric corresponding to a time available for the vehicle to continue in operation based on the predicted fault, and prompt the control system in the vehicle to degrade operation of the vehicle based on the time-to-failure metric.
